(19) United States
(12) Patent Application Publication
(10) Pub. No.: US 2006/0148457 A1
(43) Pub. Date: Jul. 6, 2006

(54) METHOD AND APPARATUS FOR DETERMINATION OF A REPLY ADDRESS IN A VOICE SIGNAL

(75) Inventor: Michael S. Borella, Naperville, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTSTARCOM, INC., Alameda, CA (US)

(21) Appl. No.: 10/905,377

(22) Filed: Dec. 30, 2004

(51) Int. Cl. H04M 3/42; H04M 1/00; H04B 1/38

(52) U.S. Cl. 455/415; 455/563

(57) ABSTRACT

A reply address is determined from within a voice signal. Voice recognition is performed on at least a portion of the received voice signal to identify the reply address. A user is presented with at least one reply address and confirms a reply address to enable a reply communication such as a call back or text message. The inventions can provide a callback feature for a voice mail system.

### BACKGROUND OF THE INVENTIONS

1. Technical Field

The present inventions relate to voice communications and, more particularly, relate to the determination of reply information within voice signals.

2. Description of the Related Art

Some voice mail systems are known to have a callback feature. After a user retrieves and listens to his voicemail, the system prompts the user to return the call. This mechanism is typically based on incoming caller ID. The voicemail system stores the number received from caller ID with the message so that it can automatically dial out to allow the user to return the call.

Such a feature is very useful for a busy person checking their voicemail. For example, if a voice mail users are driving, walking, or in any other situation where they don't have a means of writing down a number that is left in a voice mail message, they have to either scramble to find a pen or pencil, or try to remember the number of the caller. Doing so is inconvenient and error prone.

Relying on caller ID for the caller's number, however, is not foolproof for at least three reasons:
Many phones, systems or service providers block outgoing caller ID.
The number that the caller wants the voice mail user to call back to may not be the caller ID number. For example the caller may be at his desk phone, a public phone, or his home phone and he asks the voice mail user to call him back at his cell phone, and leaves that number.
The caller leaves two or more numbers, for example a daytime and an evening number.

All of these cases are very common today and would render a caller ID based callback feature useless.

### SUMMARY OF THE INVENTIONS

An object of the present inventions is to recognize a callback number from a voice signal.

Another object of the present inventions is to recognize callback information by use of voice recognition on a voicemail message.

A further object of the present inventions is to parse out a multi digit number from a voice signal.

An additional object of the present inventions is to parse out a text address from a voice signal.

Also an object of the present inventions is to recognize callback information by use of voice recognition in a server.

Also another object of the present inventions is to recognize callback information by use of voice recognition on a client device such as a radio telephone.

Further object of the present inventions is to determine a portion of a voice signal to analyze for callback information.

Another further object of the present inventions is for a user of a portable client device to indicate using user interface a portion of a voice signal to analyze for callback information.

Another additional further object of the present inventions is for a user of a client device choose a reply address and initiate a reply communication.

Also an additional further object of the present inventions is to perform voice recognition to identify a reply address using dialing rules for a communications system.

Also a further object of the present inventions is to perform voice recognition to identify an address using a domain name service as a dictionary.

A reply address is determined from within a voice signal. Voice recognition is performed on at least a portion of the received voice signal to identify the reply address. A user is presented with at least one reply address and confirms a reply address to enable a reply communication such as a call back or text message. The inventions can provide a callback feature for a voice mail system.

The voice recognition can be performed on a server and the reply addresses delivered to a user. The server can deliver reply addresses to the user using voice synthesis. Caller ID information can also be used to improve the choices of reply addresses presented to the user.

A user device can determine which portions of the received voice signal to analyze for a reply address by user manipulation of a user interface of a mobile communications device. A processor in a mobile communications device can store the voice signal in a look back memory and performs voice recognition on at least the identified portion of the received voice signal to identify a reply address.

The details of the preferred embodiments and other objects and features of the inventions will be readily understood from the following detailed description when read in conjunction with the accompanying drawings wherein:

### BRIEF DESCRIPTION OF THE DRAWINGS

FIG. 1 illustrates a schematic block diagram of communications system according to the present inventions;

FIG. 2 illustrates a schematic block diagram of a radio telephone according to the present inventions;

FIG. 3 illustrates a flow diagram of a server based approach according to the present inventions; and

FIG. 4 illustrates a flow diagram of a client based approach according to the present inventions.

### DETAILED DESCRIPTION OF THE PREFERRED EMBODIMENTS

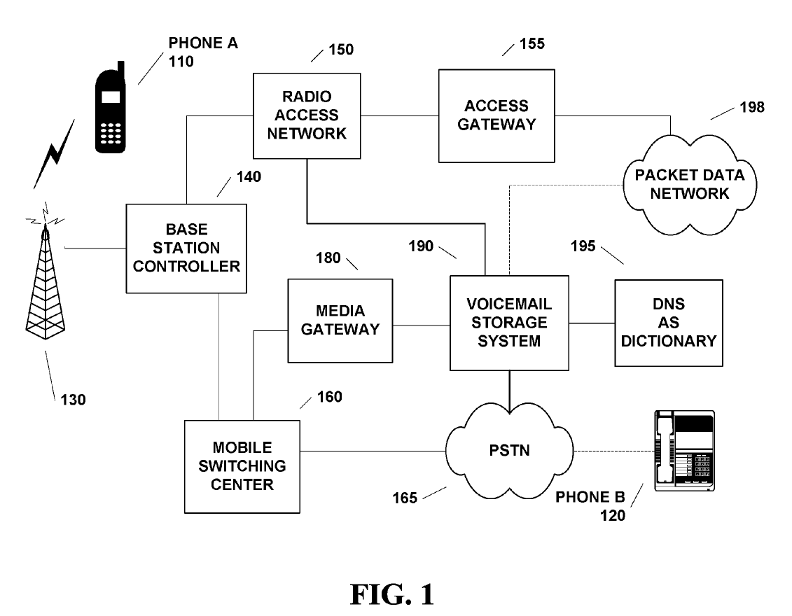

FIG. 1 illustrates a schematic block diagram of communications system according to the present inventions. A voicemail storage system 190 receives a voice signal from a telephone such as either phone A 110 or phone B 120. The telephones 110 or 120 couple to the voicemail storage system 190 via a public switched telephone network (PSTN) 165 or a cellular communications network having a radio receiver 130, a base station controller 140 and a mobile switching center 160. A media gateway 180 preferably couples the voicemail storage system 190 to these components. The telephones can use a voice over internet protocol (VoIP) or other transport such as the PSTN for the voice signal.

A user of telephone 110 or 120 is presented by the voicemail storage system 190 and the media gateway 188 with at least one reply address. The user of the telephone 110 or 120 then confirms the reply address and initiates a reply communications such as a callback phone call or a text message such as an email or instant message. The voicemail storage system 190 performance voice recognition not at least a portion of the received voice signal to identify the reply address.

The voicemail storage system 190 can deliver the reply address to the user using voice synthesis. The voicemail storage system 190 can alternatively deliver the reply address is to the user using a message. For instance, the reply address can be presented to the user of the telephone 110 or 120 using a messaging protocol such as the Short Messaging Service (SMS) or Session Initiation Protocol Uniform Resource Indicator (SIP URI).

The telephone 110 or 120 can identify portions of the received voice signal to analyze for a reply address by voice recognition. User interface of the phone by pressing a button allows identification of the portion of the way single to analyze. The identified portions are then communicated to the voicemail storage system 190 for subsequent recognition.

A phone 110 or 120 can also store the voice signal in a look back or FIFO memory for voice recognition within the telephone. Use of identified portions for speech recognition is particularly useful in a phone to reduce demand on its processor and battery.

The voicemail storage system 190 can combine the callback information obtained by performing voice recognition in the voice signal and caller ID information obtained correctly from the received call. The caller ID information can then be presented to a user together with the reply address.

The voicemail storage system 190 performs voice recognition to preferably identify a telephone number and the voice signal. The voicemail stored system can alternatively identify an email address using a domain name system (DNS) as a dictionary 195 for the voice recognition. The voicemail storage system 190 can also identify a universal resource indicator (URI) in the voice signal. Further the voicemail storage system can identifies a reply address using dialing rules for a given communications system.

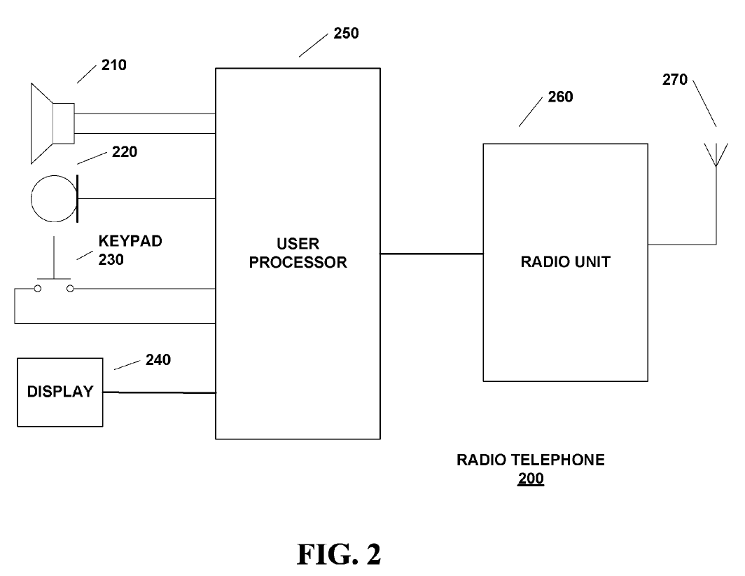

FIG. 2 illustrates a schematic block diagram of a radio telephone 200 according to the present inventions. A radio unit 260 receives voice signals via an antenna 270 over a radio telephone channel. A user processor 250 is connected to the radio unit 260 and presents at least one reply address to the user of the radio telephone 200. A user processor 250 of the radio telephone 200 controls a user interface. The user interface to the radio telephone 200 has a keypad 230 and a display 240. The user interface of the radio telephone 200 may also have a speaker 210 and a microphone 220. The user interface allows the user of the radio telephone to confirm a reply address. The reply address, once confirmed, then initiates a reply communication via the radio unit 260.

The user processor 250 can either perform voice recognition directly on the voice signal in a first instance. In a second instance the voice recognition can be performed in a remote server and the user processor 250 receive the recognized reply addresses from the server via the radio unit 260. In the second instance the server delivers the recognized text to the user processor.

In the first instance a voicemail storage system performs voice synthesis to present a user with at least one reply address. Alternatively, in the first instance, the voice mail storage system provides the reply address is to the radio telephone 200 using a messaging protocol or other IP protocol.

The user interface allows the user of the radio telephone 200 to mainly identify which portion of the received voice signal to analyze for a reply address. The user can identify the portion to analyze by manipulating the user interface and pricing, for example, a button on the keypad 230. In the first instance where the user processor 250 of the radio telephone performs the voice recognition, a look back memory in the radio telephone 200 is used for the voice recognition of the at least one identified portion of the voice signal.

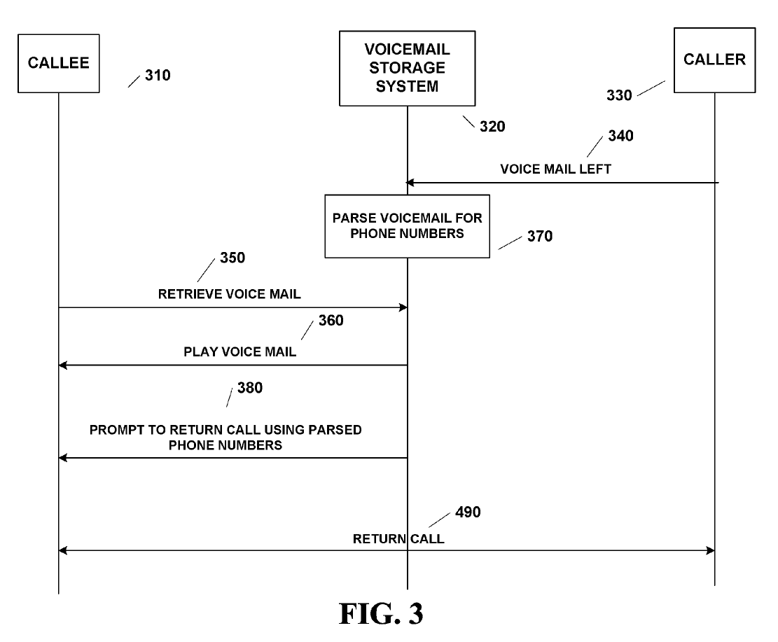

FIG. 3 illustrates a flow diagram of a server based approach according to the present inventions. A caller 330 at a telephone leaves a voicemail 340 and a voicemail storage system 320. The voicemail storage system 320 parses the voicemail 370 for reply addresses such as phone numbers. A domain name server is preferably used to parse the voicemail 370 for addresses containing domain names. The voicemail can also be parsed 370 for telephone number reply addresses using dialing rules for the communications system. A callee 310 at another telephone retrieves a voicemail 350. The voicemail store system 320 plays the voicemail 360 to the callee 310. The voicemail store system 320 prompts the callee to return the call using parsed reply address such as phone numbers 380. The callee 310 then returns the call 490 using the parsed reply address such as the phone number.

Note that other strings of numbers might appear in a voice mail, so the voice mail number recognition system must be able to differentiate a phone number from another string of numbers, such as a social security number or a bank account routing number. A method for doing this would apply dialing rules to the voice recognition for the communication system in which the inventions are implemented. For example, in the US, most phone numbers are 7 or 10 digits in length. If the recognition system finds a number that is not 7 or 10 digits, it should not store that number with the message. Thus, the voice mail system should have a local policy module that can be changed based on the dialing plan of the user's region or system. The dialing rules would also apply to an enterprise or PBX dialing convention assuming that was also part of the given communications system in which the inventions were implemented.

Voice recognition on the voicemail message to parses out say a 10 digit number. In the server, the voicemail is received at the server and parsed using voice recognition by searching for a 10 digit number. If one or more numbers are found, they are stored with the voice message. Alternatively these numbers can be searched for in real time, but a voice mail system is likely to have spare cycles in which to do the search in the background, before the message is retrieved.

When a voice mail user retrieves his voicemail, the message is played. When it is finished, the user is prompted to call back using one or more of the stored numbers. The numbers can be read to the user with the voice mail system so that more than one number can be differentiated.

If no number is found in the message, the voice mail system can fall back on the caller ID method.

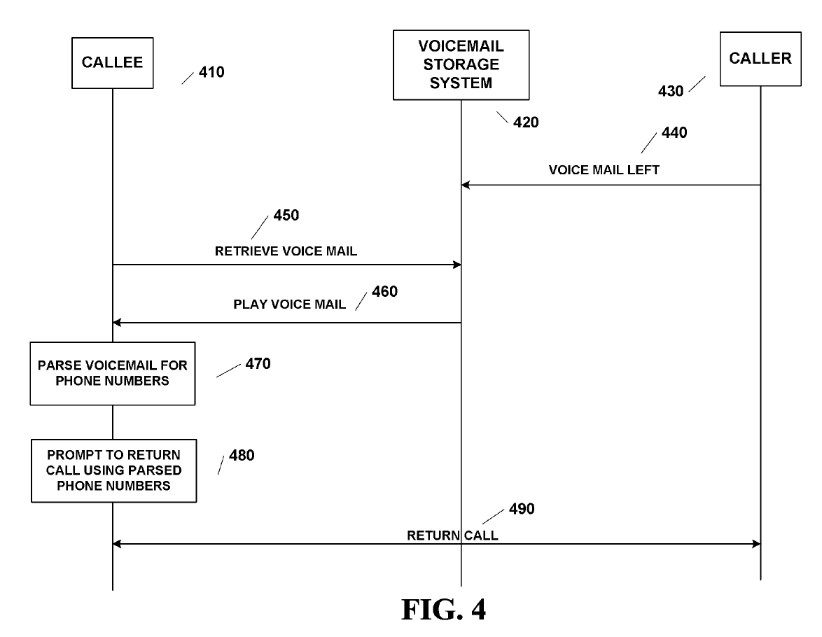

FIG. 4 illustrates a flow diagram of a client based approach according to the present inventions. A caller 430 at a telephone leaves a voicemail 440 on the voicemail storage system 420. A callee 410 at another telephone retrieves the voicemail 450. The voicemail stored system 420 plays the voicemail 460 to the callee 410. The callee phone parses the voicemail for phone numbers using a user processor of the telephone and voice recognition on telephone. The phone of the callee 410 user returns the call using the reply address, such as parsed phone numbers 480. The callee 410 then returns the call 490 to the caller 430 using, for example, the return telephone number of the caller identified in the present inventions.

Though a cell or radio telephone is the client device illustrated in the preferred embodiments, other types of phones can be used as well.

The voice recognition may be done on the user's client itself. Modern mobile or cell phones already have voice recognition capabilities and their processing power increases regularly. However, this processing would have to be real time, since the mobile phone doesn't store the message. Thus, when the message is played out to the user, the voice recognition software on the mobile phone will parse the message for numbers. The user won't necessarily be prompted by the voice mail system to call back the caller. However, when the user terminates the call, the mobile phone can prompt the user with one or more of the recognized numbers. The user can then choose to dial them.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, the inventions can be applied to memo recorders.

What is claimed is:

1. A method of determining a reply address in a voice signal, said method comprising the steps of:
(a) receiving a voice signal;
(b) performing voice recognition on at least a portion of the received voice signal to identify a reply address; and
(c) presenting a user with at least one reply address to confirm a reply address and enable a reply communication.

2. A method of determining a reply address in a voice signal according to claim 1, wherein said step (a) of receiving a voice signal comprises obtaining the voice signal from storage in a voice mail system.

3. A method of determining a reply address in a voice signal according to claim 1, wherein said step (a) of receiving a voice signal comprises obtaining the voice signal from a received telephone call.

4. A method of determining a reply address in a voice signal according to claim 3,
wherein said step (a) of obtaining the voice signal from a received telephone call further comprises the step of obtaining caller ID information from the received call; and
wherein said step (c) of presenting a user with at least one reply address comprises the step of presenting a user with at least one reply address including caller ID information in addition to any reply address identified by voice recognition.

5. A method of determining a reply address in a voice signal according to claim 1,
wherein said step (b) of performing voice recognition on at least a portion of the received voice signal comprises the step of performing voice recognition on at least a portion of the received voice signal to identify a telephone number; and
wherein said step (c) comprises the step of confirming a reply address to enable a telephone call.

6. A method of determining a reply address in a voice signal according to claim 1,
wherein said step (b) of performing voice recognition on at least a portion of the received voice signal comprises the step of performing voice recognition on at least a portion of the received voice signal to identify a telephone number; and
wherein said step (c) comprises the step of confirming a reply address to enable a text message.

7. A method of determining a reply address in a voice signal according to claim 1,
wherein said step (b) of performing voice recognition on at least a portion of the received voice signal comprises the step of performing voice recognition on at least a portion of the received voice signal to identify an email address; and
wherein said step (c) comprises the step of confirming a reply address to enable an email message.

8. A method of determining a reply address in a voice signal according to claim 1, wherein said step (b) of performing voice recognition on at least a portion of the received voice signal to identify a reply address comprises the step of using a domain name server (DNS) as a dictionary for the voice recognition.

9. A method of determining a reply address in a voice signal according to claim 1, wherein said step (c) of presenting a user with at least one reply address comprises the step of presenting a universal resource Indicator (URI).

10. A method of determining a reply address in a voice signal according to claim 1, wherein at least said step (a) of obtaining a voice signal and said step (b) of performing voice recognition are performed on a server.

11. A method of determining a reply address in a voice signal according to claim 1, wherein said step (c) of presenting a user with at least one reply address comprises the step of delivering at least one candidate reply addresses from a server to a user device on a messaging protocol.

12. A method of determining a reply address in a voice signal according to claim 1, wherein said step (b) of performing voice recognition on at least a portion of the received voice signal to identify a reply address comprises the steps of
(b1) determining which portions of the received voice signal to analyze for a reply address; and
(b2) analyzing the determined portions of the received voice signal by a voice recognition process to identify one or more candidate reply addresses.

13. A method of determining a reply address in a voice signal according to claim 12, wherein said step (b1) of determining which portions of the received voice signal to analyze for a reply address comprises the step of identifying the portions by a user manipulating a user interface of a mobile communications device.

14. A method of determining a reply address in a voice signal according to claim 12,
wherein said step (b) of performing voice recognition on at least a portion of the received voice signal to identify a reply address further comprises the step of (b3) storing the voice signal; and
wherein at least one of steps (b1) and (b2) include look back in a memory.

15. A method of determining a reply address in a voice signal according to claim 1, wherein at least said step (c) of presenting a user with at least one reply address is performed on a mobile communication device.

16. A method of determining a reply address in a voice signal according to claim 15, wherein at said step (a) of obtaining a voice signal, and said step (b) of performing voice recognition are further performed on the mobile communication device.

17. A method of determining a reply address in a voice signal according to claim 1, wherein said step (b) of performing voice recognition on at least a portion of the received voice signal to identify a reply address comprises the step of identifying return callback information.

18. A method of determining a reply address in a voice signal according to claim 1, wherein said step (c) of presenting a user with at least one reply address comprises the substeps of:
(c1) presenting a user with a menu of at least one reply address; and
(c2) selecting a reply address from the menu to initiate a reply communication.

19. A method of determining a reply address in a voice signal according to claim 1, wherein said step (c) of presenting a user with at least one reply address comprises the step of presenting a user with the menu of at least one reply address via voice synthesis.

20. A method of determining a reply address in a voice signal according to claim 1, wherein said step (b) of performing voice recognition on at least a portion of the received voice signal to identify a reply address comprises the step of performing voice recognition to identify a reply address using dialing rules for a given communications system.

21. A radio telephone capable of determining a reply address in a voice signal, comprising:
a radio unit for receiving a voice signal;
a user processor operatively coupled to the radio unit to present a user with at least one reply address; and
a user interface operatively coupled to the user processor to allow the user to confirms a reply address to initiate a reply communication via the radio unit.

22. A radio telephone according to claim 21, wherein the radio unit receives identified reply addresses from a remote server.

23. A radio telephone according to claim 21, the user processor identifies which portion of the received voice signal to analyze for a reply address by a user manipulating a user interface of a mobile communications device.

24. A radio telephone according to claim 23, wherein the user processor stores the voice signal in a look back memory and performs voice recognition on at least the identified portion of the received voice signal to identify a reply address.

25. A method of voice recognition, comprising:
(a) receiving a voice signal; and
(b) performing voice recognition on the voice signal to identify an address, wherein the voice recognition uses a domain name service as a dictionary.
